(19) United States
(12) Patent Application Publication
(10) Pub. No.: US 2026/0049824 A1
(43) Pub. Date: Feb. 19, 2026

(54) AUTOMATED VEHICLE MANAGEMENT FOR OCCUPANT-COUNT RESTRICTED ROAD SEGMENTS

(71) Applicant: Tesla, Inc., Austin, TX (US)

(72) Inventors: Dev Urvi Jatin Bhatia, Austin, TX (US); Stergios Hetelekides, Mountain View, CA (US); Xufan Wang, Austin, TX (US); Aleksei Potov, Los Gatos, CA (US)

(21) Appl. No.: 19/300,410

(22) Filed: Aug. 14, 2025

Related U.S. Application Data
(60) Provisional application No. 63/684,258, filed on Aug. 16, 2024.

(51) Int. Cl. G01C 21/34; G06V 20/59; G08G 1/0968

(52) U.S. Cl. CPC G01C 21/3461; G06V 20/593; G08G 1/096811

(57) ABSTRACT

Systems and methods for adjusting vehicle navigation for occupant-count restricted road segments (e.g., HOV lane, carpool lane, etc.). Specifically, systems and methods for automating navigation of a vehicle to an occupant-count restricted road segment by determining the number of passengers in the vehicle. The systems and methods may determine the number of passengers in a vehicle using a plurality of sensors and camera in the vehicle. The systems and methods may also determine the existence of the occupant-count restricted road segment based on map data and camera data. If the systems and methods determine the number of passengers in the vehicle is appropriate, the vehicle can be routed to that occupant-count restricted road segment.

### CROSS-REFERENCE TO RELATED APPLICATIONS

This application claims priority to U.S. Prov. Patent App. No. 63/684,258 titled “AUTOMATED VEHICLE MANAGEMENT FOR OCCUPANT-COUNT RESTRICTED ROAD SEGMENTS” and filed on Aug. 16, 2024, which is hereby incorporated herein by reference in its entirety.

### TECHNICAL FIELD

This disclosure relates to systems and methods for adjusting vehicle navigation for occupant-count restricted road segments (e.g., High Occupancy Vehicle (HOV) lane, carpool lane, etc.). Specifically, this disclosure relates to systems and methods for automating navigation of a vehicle to an occupant-count restricted road segment by determining the number of passengers in the vehicle.

### BACKGROUND

In the context of vehicle navigation, existing vehicles may use navigation systems that can route a driver to a destination. Existing vehicle navigation systems may determine a route for routing the vehicle to a destination from a specified location. Existing vehicle navigation systems may monitor location information and determine and update routes between the monitored location and the destination as the vehicle is driving.

### SUMMARY

The devices, systems, and methods disclosed herein have several features, no single one of which is solely responsible for its desirable attributes. Without limiting the scope as expressed by the claims that follow, its more prominent features will now be discussed briefly. After considering this discussion, and particularly after reading the section entitled “Detailed Description” one will understand how the features of one or more embodiments of the system and methods provide several advantages over traditional systems and methods.

In some aspects, the techniques described herein relate to a method performed by a processor in a vehicle, comprising receiving image data and sensor data from inside the vehicle; determining, based on the image data and the sensor data from inside the vehicle, a count of number of passengers in the vehicle; obtaining map data related to occupant-count restricted road segments; receiving image data and sensor data from outside the vehicle; determining, based on the image data and the sensor data from outside the vehicle and the map data, existence of the occupant-count restricted road segment; and adjusting vehicle navigation data towards the occupant-count restricted road segments based on the count.

In some aspects, the techniques described herein relate to a method performed by a processor in a vehicle. The method can include receiving passenger sensor data from the vehicle; determining, based on the passenger sensor data from inside the vehicle, a count of number of passengers in the vehicle, determining an occupant-count restricted road segment in an environment of the vehicle, and adjusting vehicle navigation of a driving route to enter the occupant-count restricted road segment based on the count.

In some embodiments, the method further includes transmitting the count, a current location, and a destination to an outside server, wherein the outside server determines navigation data for routing the vehicle; and receiving the navigation data from the outside server based on the count, the current location, and the destination.

In some embodiments, the passenger sensor data is received from inside the vehicle from at least one of one or more seat occupancy sensors, one or more seatbelt latch detectors, one or more radar sensors, or one or more interior cameras.

In some embodiments, the method further includes determining, based on at least one of sensor data from outside the vehicle or map data, existence of the occupant-count restricted road segment.

In some embodiments, the map data includes at least one of traffic data, offline maps, online maps, or occupant-restricted road segment entry requirement data.

In some embodiments, adjusting the vehicle navigation includes self driving the vehicle to the occupant-count restricted road segment.

In some embodiments, adjusting the vehicle navigation includes displaying an indication to a driver of the vehicle to drive to the occupant-count restricted road segment.

In some embodiments, the method further includes inputting the count into an occupant-count restricted road segment transponder.

In some embodiments, determining, based on the passenger sensor data from the vehicle, the count of number of passengers in the vehicle includes identifying one or more passengers in the vehicle based on the passenger sensor data, wherein the passenger sensor data indicates a presence of the one or more passengers, and summing the identified passengers in the vehicle to determine the count.

In some embodiments, determining the count of number of passengers in the vehicle cand include applying a first weight a first set of passenger sensor data and a second weight to a second set of passenger sensor data; and based on the first weight, the first set of passenger sensor data, the second weight, and the second set of passenger sensor data, determining whether individual seats of the vehicle are occupied with a passenger.

In some aspects, the techniques described herein relate to a system. The system can include one or more processors and computer storage media storing instructions that when executed by the processors, cause the processors to receive passenger sensor data from a vehicle, determine, based on the passenger sensor data from inside the vehicle, a count of number of passengers in the vehicle, determine an occupant-count restricted road segment in an environment of the vehicle, and adjust vehicle navigation of a driving route to enter the occupant-count restricted road segment based on the count.

In some embodiments, to determine, based on the passenger sensor data from the vehicle, the count of number of passengers in the vehicle further causes the processors to identify one or more passengers in the vehicle based on the passenger sensor data from the vehicle, the passenger sensor data from the vehicle indicating a presence of the one or more passengers, and sum the identified passengers in the vehicle to determine the count.

In some embodiments, the instructions further cause the processors to determine, based on at least one of sensor data from outside the vehicle or map data, existence of the occupant-count restricted road segment.

In some embodiments, the map data includes at least one of traffic data, offline maps, online maps, or occupant-count restricted road segment entry requirement data.

In some embodiments, the passenger sensor data is received from inside the vehicle from at least one of one or more seat occupancy sensors, one or more seatbelt latch detectors, one or more radar sensors, or one or more interior cameras.

In some aspects, the techniques described herein relate to a computer program product, the computer program product being embodied in a non-transitory computer readable storage medium. The computer program product can include computer instructions for receiving passenger sensor data from a vehicle, determining, based on the passenger sensor data from inside the vehicle, a count of number of passengers in the vehicle, determining an occupant-count restricted road segment in an environment of the vehicle, and adjusting vehicle navigation of a driving route to enter the occupant-count restricted road segment based on the count.

In some embodiments, the passenger sensor data is received from inside the vehicle from at least one of one or more seat occupancy sensors, one or more seatbelt latch detectors, one or more radar sensors, or one or more interior cameras.

In some embodiments, the computer program product further includes computer instructions for determining, based on image data from outside the vehicle and map data, an existence of the occupant-count restricted road segment.

In some embodiments, the map data includes at least one of traffic data, offline maps, online maps, or occupant-restricted road segment entry requirement data.

In some embodiments, the computer program product further includes computer instructions for transmitting the count, a current location, and a destination to an outside server, wherein the outside server determines navigation data for routing the vehicle, and receiving the navigation data from the outside server based on the count, the current location, and the destination.

### BRIEF DESCRIPTION OF THE DRAWINGS

These and other features, aspects and advantages of the present disclosure are described herein with reference to drawings of preferred embodiments, which are intended to illustrate, and not to limit, the present disclosure.

FIG. 1 illustrates components of an example environment for an automated vehicle navigation system for occupant-count restricted road segments in accordance with aspects of the present disclosure.

FIG. 2 depicts illustrative interactions between the components of the automated vehicle navigation system to adjust vehicle navigation for occupant-count restricted road segments in accordance with some aspects of the disclosure.

FIG. 3 illustrates an example routine implemented by the vehicle in accordance with some aspects of the disclosure.

FIG. 4 illustrates an example routine implemented by a server in communication with the vehicle in accordance with some aspects of the disclosure.

FIG. 5 is a block diagram that illustrates the general architecture of a vehicle implementing the system of FIG. 1.

### DETAILED DESCRIPTION

Generally described, one or more aspects of the present disclosure relate to systems and methods for adjusting vehicle navigation based on monitoring of a number of occupants in a vehicle, for example to determine compliance with use of an occupant-count restricted road segment (e.g., carpool lane, HOV lane, etc.). Specifically, the present disclosure relates to determining, using cameras and sensors inside the vehicle, the number of occupants in a vehicle, determining the existence of a carpool lane along a driving route, and adjusting navigation of the vehicle or vehicle navigation instructions to use the carpool lane when there is an appropriate number of occupants in the vehicle for an identified carpool lane along the driving route.

The vehicle implementing aspects of the present disclosure may use an interior cabin camera or cameras, optionally along with other in-cabin sensors, to identify the number of passengers in the vehicle. In addition, the vehicle implementing aspects of the present disclosure may use the identified number of passengers along with map data to automatically determine in real-time if the vehicle may use any carpool lanes during either autonomous driving or for route calculation to a destination a user has selected. Vehicle navigation may include the car autonomously or semi-autonomously driving, where the vehicle may navigate by performing road or lane selection as it is driving. For example, the vehicle may select a lane of a road (e.g., a freeway) while navigating along a route based on whether the vehicle is able to drive in an HOV lane according to the identified number of passengers.

In addition to initially estimating the number of occupants in the vehicle, the vehicle may periodically (e.g., every 10 seconds, 20 seconds, 60 seconds, etc.) check the number of occupants in the vehicle in case the number of occupants may have changed and update the route or trajectory accordingly. For example, if a person were to exit or enter the vehicle, the vehicle can determine an updated number of occupants. In another example, the vehicle may be a robotaxi (e.g., autonomously driving taxi) that can estimate the number of passengers that will be in the vehicle at various points in the trip, such as when the robotaxi drops off and picks up passengers. Based on the projected number of passengers at various points in the trip, the vehicle can plan the route or trajectory accordingly. The vehicle may optionally utilize heuristics to further determine whether the number of occupants in the vehicle has changed. The heuristics may include various ways to determine that an occupant has entered or exited the vehicle, such by analyzing the opening and closing of the car doors, identifying a change in weight from a seat sensor, or determining the seatbelt has become buckled or unbuckled, etc. In addition, the vehicle may also use exterior cameras to see if an occupant has left the vehicle.

Once the vehicle has determined a number of occupants in the vehicle, the vehicle can provide the number of occupants to a server which can determine the route or trajectory along the route of the vehicle. The server can determine a route or trajectory incorporating the number of occupants in the vehicle. For example, if there are an appropriate number of occupants in the vehicle, the server can determine a route or routes that has an available carpool lane. The server can send the routes and/or trajectory along the route to the vehicle for navigation. The vehicle therefore receives routes which take the number of occupants into account. However, this is not meant to be limiting or required. In embodiments, the vehicle can use locally stored map data and determine the number of occupants in the vehicle and a corresponding route without interacting with an outside server, where the vehicle can route itself. Alternatively, the vehicle may determine the carpool lane is available along the route provided by the server, determine there is an appropriate number of occupants in the vehicle, and therefore navigate the vehicle to the carpool lane regardless of the route provided by the server.

In other embodiments, the vehicle may perform the navigation without accessing an external server. For example, the vehicle itself may determine a route between two points incorporating the number of occupants in the vehicle. In another example, the vehicle may determine selection of a carpool lane along a route based on its number of occupants. The lane selection may not impact the overall route of the navigation, such as where the vehicle may use the same roads as previously determined for the route but uses the carpool lane instead of regular lanes of the road. However, in other examples, the lane selection may impact the overall route of the navigation where the use of a carpool lane causes a different route to be determined.

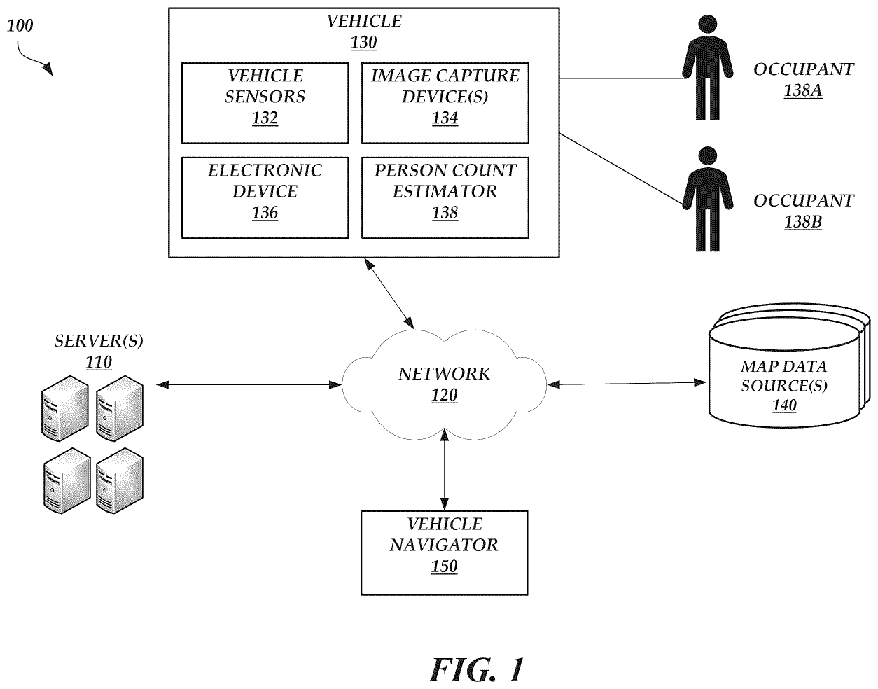

The vehicle may display the received routes on a navigation user interface (UI) that is displayed to a user. For example, the navigation UI may display the proposed route from the server, and the UI may include instructions to use a carpool lane. However, as described in FIG. 1, the vehicle may include a self-driving mode, where the vehicle can self-drive into the available carpool lane based on the navigation data.

The features described in the present disclosure may be enabled or disabled by a user of the vehicle. The vehicle can be configured to always use carpool lanes, never use carpool lanes, or automatically use carpool lanes using the features described herein. For example, the vehicle may include a UI setting where a user can select whether to enable the features for automatically using the carpool lane.

Existing vehicle navigation systems are currently unable to determine the number of passengers in the vehicle and navigate the vehicle into an occupant-count restricted road segment based on the determined number of passengers. As a result, traditional navigation systems may navigate the vehicle in a less efficient route and result in increased travel times, cost, and strain on the vehicle. The systems and methods described herein resolve these deficiencies by providing a mechanism for automatically routing a vehicle into a carpool lane after determining the number of occupants in a vehicle. This allows the vehicle to navigate users faster and more efficiently. For example, current navigation systems that do not use occupancy of the vehicle may navigate around an area of a freeway with heavy traffic, even though the carpool lane may be open on that freeway. The presently described vehicle may therefore prefer routing to the freeway using the carpool lane and can save time and mileage on the vehicle and improve the user's experience.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

FIG. 1 illustrates components of an example environment 100 for an automated vehicle management system for occupant-count restricted road segments in accordance with aspects of the present disclosure. With reference to FIG. 1, there is shown an exemplary network environment 100. The exemplary network environment 100 may include a server or servers 110, a wireless communication network 120, a vehicle 130, including vehicle sensors 132, image capture device(s) 134, an electronic device 136, and a person count estimator 138, map data source(s) 140, and a vehicle navigator 150.

The server 110 may comprise suitable logic, circuitry, interfaces, and/or code that may be configured to establish a communication channel with one or more vehicles, such as the vehicle 130. The server 110 may be configured to receive information from various vehicles, such as the vehicle 130. The server 110 may be a cloud server, a web server, a database server, a file server, an application server, or a combination thereof. The server 110 may be implemented by use of several technologies that are well known to those skilled in the art.

The network 120 may include a long range communication medium through which one or more vehicles, such as the vehicle 130, may communicate with the server 110 or external communication devices, or registered mobile devices. Examples of the wireless communication network 120 may include, but are not limited to, the Internet, Internet-based mobile ad hoc networks (IMANET), a cellular network, such as a 3G, 4G, or 5G network, a cloud network, and/or a Wide Area Network (WAN). Various devices in the network environment 100 may be configured to connect to the wireless communication network 120, in accordance with various wireless communication protocols. Examples of such wireless communication protocols may include, but are not limited to, IEEE 802.11, 802.11x, 802.15, 802.16, 1609, Worldwide Interoperability for Microwave Access (Wi-MAX), Wireless Access in Vehicular Environments (WAVE), cellular communication protocols, Transmission Control Protocol and Internet Protocol (TCP/IP), User Datagram Protocol (UDP), Hypertext Transfer Protocol (HTTP), LTE, File Transfer Protocol (FTP), ZigBee, EDGE, Li-Fi, and/or other wireless communication protocols.

The vehicle 130 may include one or more vehicle sensors 132, an image-capture device 134, an in-vehicle electronic device 136, and a person count estimator 138. There is further shown an occupant 138A and an occupant 138B associated with the vehicle 130. The vehicle sensors 132 may include one or more seat occupancy sensors, one or more seatbelt latch detectors, one or more interior cameras, or one or more radar sensors that can detect the presence of a person in the vehicle 130. The vehicle sensors 132 may also include one or more exterior cameras and one or more microphones. The image-capture device(s) 134 may be installed in the interior of the vehicle 130 to capture a plurality of images or a video of one or more occupants, such as the occupant 138A and the occupant 138B, in the vehicle 130. Occupant identification methods to determine if there is an occupant may include, for example, human identification from a body shape based on human object boundary or silhouette matching. In addition, the image-capture device 134 may be installed on the exterior of the vehicle 130 to capture a plurality of images or a video of the surroundings of the vehicle 130. Exterior cameras may be used to confirm if an occupant has left or entered the car. In some situations, the interior camera may not be able to detect a person in the vehicle and therefore the exterior cameras may supplement the interior cameras. These situations may include where the person is outside the view of the camera, such as by leaning against a window, or the camera is otherwise blocked (e.g., covered with tape or other obstacle). The in-vehicle electronic device 136 may refer to an in-vehicle infotainment (IVI) system or an electronic control unit (ECU) of the vehicle 130.

The vehicle 130 may be an autonomous vehicle or a semi-autonomous vehicle, for example, as defined by National Highway Traffic Safety Administration (NHTSA). In some embodiments, the vehicle 130 may be a non-autonomous vehicle. Examples of the vehicle 130 include, but are not limited to, an electric vehicle, a hybrid vehicle, a gas-combustion vehicle, and/or a vehicle with autonomous drive capability that uses one or more distinct renewable or non-renewable power sources. A vehicle that uses renewable or non-renewable power sources may include a fossil fuel-based vehicle, an electric propulsion-based vehicle, a hydrogen fuel-based vehicle, a solar-powered vehicle, and/or a vehicle powered by other forms of alternative energy sources. There are a plurality of different categories or levels of vehicles of what is considered to be semi-autonomous and autonomous, for example the classification according to NHTSA. The personalization system and method of the present disclosure may be applied to the plurality of differ categories or levels of vehicles that includes non-autonomous to fully-autonomous vehicles.

The vehicle sensors 132 may comprise suitable logic, circuitry, interfaces, and/or code that may be configured to capture a plurality of data which can indicate the presence of an occupant in the vehicle, such as the occupant 138A and/or the occupant 138B, or the presence of a carpool lane. The vehicle sensors 132 may include one or more seat occupancy sensors, one or more seatbelt latch detectors, one or more interior cameras, one or more exterior cameras, one or more microphones, or one or more radar sensors. The seat occupancy sensors may include a sensor on each seat in the vehicle which can sense a weight on the seat, which may indicate there is an occupant in the seat. The seat occupancy sensors may include pressure sensors, capacitive sensors, etc. The seatbelt latch detectors may determine whether a seatbelt in the vehicle is buckled. The interior cameras may be cameras (e.g., selfie camera) that are pointed towards the interior of the vehicle and can identify occupants in the vehicle. The exterior cameras may be cameras that are pointed towards the exterior of the vehicle (e.g., towards vehicle door handles, outward from vehicle doors, or outward from the vehicle front). The microphones may be any suitable microphone sensor capable of detecting noise within the vehicle. The radar sensors may analyze the interior of the vehicle to determine if there is an occupant and how many occupants may be in the vehicle. The radar may be a supplement to the other sensors, as for example, a seat occupancy sensor or seatbelt latch detector may easily confuse an object (e.g., a backpack, child car seat, etc.) for an occupant without additional information provided.

In embodiments, the interior image-capture device 134 is positioned in the interior of the vehicle 130 such that a field-of-view of the image-capture device 134 is suitable to capture self-portrait images that include at least a face portion of all occupants (including driver and passengers) in the vehicle 130. In some embodiments, the image-capture device 134 may be installed in the vicinity of the front mirror of the vehicle 130.

The image-capture device 134 may further include an exterior camera that may detect symbols or other indicators on a roadway that the vehicle is driving on that may indicate there is a carpool lane. For example, the exterior camera may detect a diamond symbol on the roadway that indicates there is a carpool lane. The exterior cameras may also view signs along the roadway and parse text on the signs in order to determine the existence of a carpool lane. For example, the system may parse the text of a road sign capture by a camera to identify “Carpool Lane Open from 7 AM to 9 AM Monday through Friday.”

The in-vehicle electronic device 136 may comprise suitable logic, circuitry, interfaces, and/or code that may be configured to display navigation instructions to occupants in the vehicle 130 and communicate with the vehicle 130. The in-vehicle electronic device 136 may be configured to access sensor data from the image-capture device(s) 134, one or more vehicle sensors 132, and/or other vehicle data associated with the vehicle 130. The sensor data may be accessed by the in-vehicle electronic device 136, via an in-vehicle network, such as a vehicle area network (VAN) and/or in-vehicle data bus, such as a controller area network (CAN) bus. In accordance with embodiments, the in-vehicle electronic device 136 may be configured to communicate with various other vehicles in a vehicle-to-vehicle (e.g., a V2V) communication, external communication devices and/or a cloud server (such as the server 110) via the wireless communication channel or via the wireless communication network 120.

The person count estimator 138 may determine the number of occupants in the vehicle. For example, the estimator 138 may use deep-learning techniques (e.g., a convolutional or attention-based neural network) to identify distinct persons within an image frame of the interior camera. The person count estimator 138 may determine the number of occupants based on data received from the plurality of vehicle sensors 132 and image-capture device 134. The person count estimator 138 may send the count of number of occupants in the vehicle to the vehicle navigator 150 to adjust its generated navigation instructions to account for use of a carpool lane, along with any data received from the map data source(s) 140.

The map data source(s) 140 may be one or more sources of map data that contain a variety of map data used for vehicle navigation. The map data can be used to additionally determine the existence of a carpool lane along a driving route in the navigation. The map data may include traffic data, offline maps, online maps, and/or carpool lane entry requirement data. The traffic data may include real-time data indicating the level of traffic on a roadway. Offline maps may be maps accessible to the system with or without a connection to a server. Carpool lane entry requirements may include data such as opening and closing times of a carpool lane, occupant minimums for allowed entry into the carpool lane, occupant minimums based on time for allowed entry into the carpool lanes, and the like. Thus, usage of a carpool lane may change depending time. For example, the vehicle may autonomously or semi-autonomously select a carpool lane by, in part, verifying time constraint.

The vehicle navigator 150 may be a system or component that can generate and provide instructions for navigation of the vehicle. For example, the vehicle navigator 150 may use map data from the map data source(s) 140 to determine a route or trajectory of the vehicle based on a starting point and an end point. The vehicle navigator 150 can receive the count of number of occupants from the vehicle 130 in order to determine a route or trajectory. The vehicle navigator 150 may additionally incorporate map data and/or sensor data to determine the existence of a carpool lane for incorporation in the determined route or trajectory.

Although the vehicle navigator 150 is depicted in FIG. 1 as separate from the vehicle 130, this is not meant to be limiting or required. In embodiments, the vehicle navigator 150 may be included as part of the vehicle 130 or within the in-vehicle electronic device 136 of the vehicle 130.

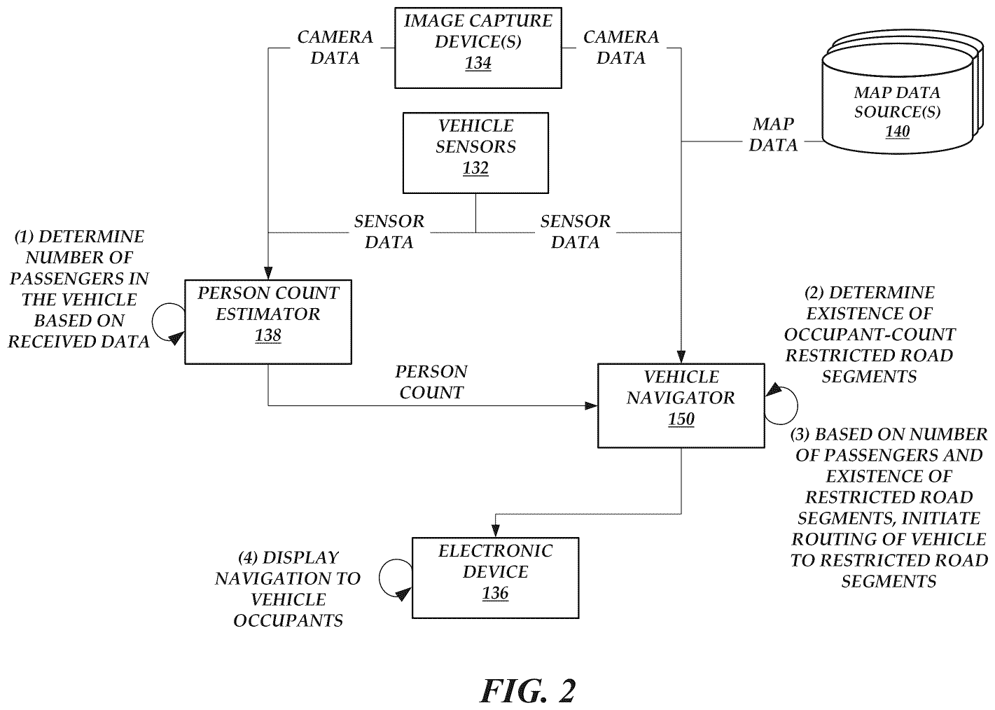

FIG. 2 depicts illustrative interactions between the components of the automated vehicle management system 100 to adjust vehicle navigation for occupant-count restricted road segments in accordance with some aspects of the disclosure. The image-capture device 134 may send camera data, such as images and/or videos, to the person count estimator 138 and the vehicle sensors 132 may send sensor data to the person count estimator 138. At (1), the person count estimator 138 may determine the number of passengers in the vehicle based on the received data. For example, the person count estimator 138 may be able to determine the count by processing the images and/or videos from the image-capture device 134 and by processing sensor data from the vehicle sensors 132 to identify persons in the vehicle. For example, the image or video data may identify one or more people in the vehicle. As some examples, the sensor data may indicate that there is a person sitting in a seat based on the weight pressed down on the seat, there is a seatbelt buckled, and/or there are one or more people in the vehicle as identified using radar. The person count estimator 138 can identify each person in the vehicle and sum up the number of identified people to get the person count. The person count estimator 138 may send the person count to the vehicle navigator 150.

At (2), the vehicle navigator 150 may determine the existence of an occupant-count restricted road segment along the driving route. First, the map data source(s) 140 may send map data, the vehicle sensors 132 may send sensor data, and the image capture devices 134 may send camera data to the vehicle navigator 150. The vehicle navigator 150 may periodically determine the existence of the occupant-count restricted road segment while the navigation is being performed. For example, when the vehicle navigator 150 first initiates navigation, it may be the middle of the day and there is no open carpool lane. However, later in the day, the carpool lane may open up as an option. So, the vehicle navigator 150 is able to determine that there is an available carpool lane at a later point in the navigation. If the vehicle navigator 150 determines there is no occupant-count restricted road segment along the driving route and/or an insufficient number of occupants in the vehicle to use the carpool lane, then there is no need to proceed to adjusting the driving route to account for a carpool lane option and the vehicle navigator 150 can proceed with default navigation.

At (3), the vehicle navigator 150 may, based on the number of passengers and the existence of an available restricted road segment, initiate routing of the vehicle utilizing the restricted road segment. Routing of the vehicle utilizing the carpool lane may be initiated in either self-driving mode, where the vehicle can self-drive into the available carpool lane, or be displayed in the vehicle navigation as a trajectory along the route for a vehicle not in self-driving mode. For example, in self-driving mode, the vehicle can drive itself into the carpool lane if determined appropriate. In normal driving mode, the vehicle navigator 150 can display via its navigation user interface (UI) to the driver to drive into the carpool lane if determined appropriate. Regardless of the mode, at (4), the in-vehicle electronic device 136 can display the navigation instructions to the vehicle's occupants.

In embodiments, the navigation UI can show information regarding the carpool lane, such as minimum number of occupants for use of the carpool lane and/or times the carpool lane is active. The navigation UI may further display the carpool lane information as it relates to the number of the number of occupants in the vehicle and/or current time. For example, the navigation UI may display that the minimum occupant count to enter the carpool lane is 3 occupants and the carpool lane is open from 7-10 AM while displaying the occupant count and current time. This UI information may be useful if the vehicle is not being operated in an autonomous or semi-autonomous manner. For example, the driver may glance at the UI to ascertain whether the vehicle is allowed in a carpool or HOV lane. However, as stated above, the carpool lane information can be used by the vehicle in an autonomous or semi-autonomous mode, for example with use of a UI.

In embodiments, the system may integrate a carpool lane transponder (e.g., “FastPast”) into the vehicle. The transponder may be integrated into the vehicle, such that the vehicle may detect the number of occupants in the vehicle and input the number of occupants into the transponder. The vehicle can communicate with the transponder over Bluetooth, Wi-Fi, hard-wiring, and the like. The transponder can set a value of the input number of occupants in the vehicle and therefore, saving the user from having to input the number of occupants when entering a carpool lane. In addition, the vehicle can determine whether a toll is to be paid depending on the number of occupants, which can play into routing or cost preferences. For example, a driver may be more likely to use a route with a carpool lane when there are no fees versus when there are depending on user preference.

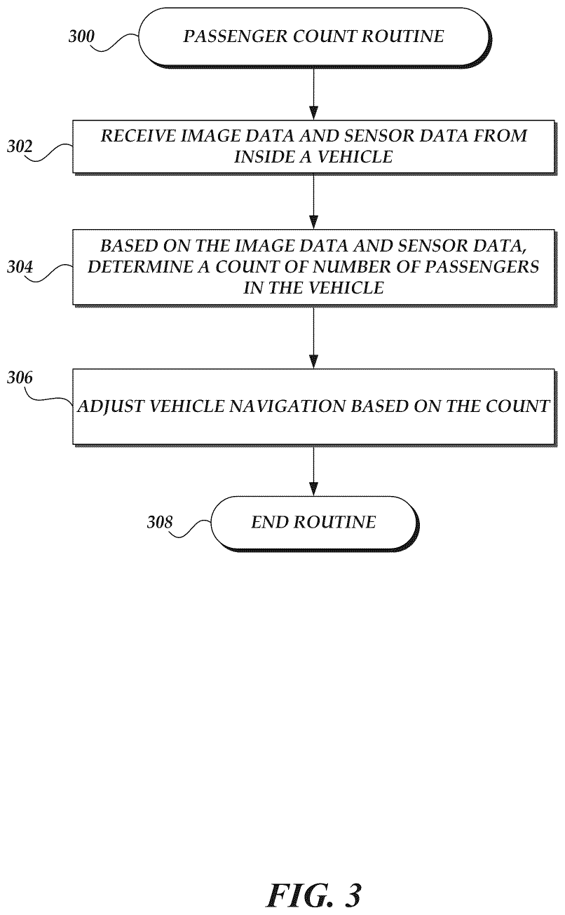

FIG. 3 illustrates an example passenger count routine 300 implemented by vehicle in accordance with some aspects of the disclosure. The routine 300 begins at block 302, where the vehicle 130 may receive image data and sensor data (referred to herein as “passenger sensor data”) from inside a vehicle. The image data and sensor data may be that as described above with respect to FIG. 1 and FIG. 2.

In embodiments, the vehicle 130 may receive image and sensor data from outside the vehicle (e.g., from exterior cameras, such as those described above with respect to FIG. 1 and FIG. 2), and the sensor data that may indicate the existence of a carpool lane along the roadway. The image and sensor data may further indicate information regarding a carpool lane, such as open and closing times of the carpool lane, distance to a carpool lane, and the like. The vehicle 130 may process the image and sensor data in order identify a carpool lane along the roadway. For example, the image data may contain an image of a sign indicating the beginning of a carpool lane in a certain distance, information regarding the carpool lane closing and opening times, and the like. In embodiments, map data may be used to identify the carpool lane.

At block 304, the vehicle 130 may determine, based on the passenger sensor data, a count of a number of passengers in the vehicle. The vehicle 130 may process the image data, which may include images and/or videos, along with the sensor data from the vehicle's cameras and sensors to identify occupants in the vehicle. The vehicle 130 can count the number of identified occupants in the vehicle to get the count of the number of passengers in the vehicle. In embodiments, the person count estimator 138, as described above with respect to FIG. 1 and FIG. 2, may determine the count.

In some instances, it may be advantageous to rely more on certain sensors or types of passenger sensor data when determining vehicle occupancy. For example, where an individual is positioned in the vehicle may alter which sensors or type of passenger sensor data are used to and/or how much particular passenger sensor data is used to determine the presence of the individual. As another example, an individual, such as a passenger in a rear seat or a child in a child safety seat, may be obstructed or may have other interference effecting the reliability of the image capture device 134 or vehicle sensors 132.

According to various embodiments, the vehicle 130 may apply weights to passenger sensor data to account for various situations. For instance, in some embodiments, the vehicle 130 may weigh image data from the image capture device 134 associated with the vehicle front seats more heavily than other passenger sensor data. For example, the image data may be more reliable, or otherwise more suitable, at detecting the presence of a passenger in the vehicle front seats than the other passenger sensor data, such as when a heavy object is in the front passenger seat. In this example, the vehicle 130 may recognize that an object is present in the seat rather than a passenger with a disengaged seatbelt. In some instances, the image data may be less reliable, or otherwise less suitable, than the sensor data. In these instances, the vehicle 130 may weigh the sensor data more heavily than the image data. For example, one or more the vehicle back seats may be completely or partially obscured from the image capture device 134. In this example, the vehicle 130 may determine a passenger is present in the obscured seats using the seat occupancy sensors, seatbelt latch detectors, and/or radar sensors and/or using the heuristics described herein.

The vehicle 130 may also apply weights to different sets of passenger sensor data (e.g., passenger sensor data coming from one or more particular sensors or the image capture device, one or more types of sensors, and/or passenger sensor data associated with a particular seat or group of seats) to account for various situations. For instance, returning to the example of a back seat that is obscured from the image capture device 134, the vehicle 130 may weigh the different sensor data according based on different criteria. For example, the vehicle 130 may, using seat occupancy sensors and/or using heuristics, determine whether a child safety seat is present in an obscured seat (e.g., the vehicle 130 may detect a constant weight in a known weight range for the child safety seat). In this example, the vehicle 130 may give greater consideration to radar sensor data or changes in weight from information received via seat occupancy sensors than the information received via the seatbelt latch detectors. As another example, if a detected child safety seat is forward faceting and not visually obscured, the vehicle 130 may give greater consideration to image data than would be given if the child safety seat was obscured or rear facing. It can pre appreciated that various situations may call for different weights than those described above.

In some embodiments, the vehicle 130 may determine the occupancy of each seat individually. The vehicle 130 may use different logic (e.g., different decision trees) to determine the occupancy for each seat. For example, to determine the occupancy of the front passenger seat, the vehicle 130 may first determine if a passenger is present using the image data and then use other information to confirm. However, if the vehicle 130 is unable to determine a passenger is present using the image data (e.g., the image-capture device 134 is obscured), the vehicle 130 may then turn to the sensor data to determine if a passenger is present.

At block 306, the vehicle 130 may accordingly adjust vehicle navigation of the vehicle according to the count. For example, the vehicle may be navigated towards the occupant-count restricted road segments based on the count. Routing of the vehicle may be initiated in either self-driving mode, where the vehicle can self-drive into the available carpool lane, or be displayed in the vehicle navigation instructions as a trajectory along the route for a vehicle not in self-driving mode.

In embodiments, the vehicle 130 may obtain information identifying a destination of the vehicle and a current location. For example, a user may input a destination for the vehicle using a navigation UI in the vehicle. The destination can be used to route the vehicle from a starting point or current location to the destination. The current location may be estimated using GPS in the vehicle 130.

Optionally, the vehicle 130 can send the passenger count, the current location, and the destination information to an outside server. The outside server can determine a navigation route and/or trajectory along a route based on the passenger count, the current location, and the destination information. The navigation route may also be determined by incorporating current map data, which may include traffic data, carpool lane information, etc., such as map data source(s) 140 as described above. The outside server can update navigation data to route to a carpool lane if the count indicates an appropriate number of occupants are in the vehicle to use a carpool lane.

The vehicle 130 may receive the navigation data from the outside server that is based on the occupant count, the current location, and the destination. The navigation data may include a route or routes that indicate where to drive the vehicle from one point (e.g., current location) to another (e.g., destination) or a trajectory that it traverses the route through, such as through selecting a carpool lane along the route if deemed appropriate.

In some embodiments, the vehicle 130 may determine, based on a current location of the vehicle, the determined occupancy of the vehicle 130, and/or navigation data (determined internally by the vehicle 130 or received from an outside server), that the vehicle 130 is improperly in an occupancy restricted lane or road. The vehicle 130 may, after making such a determination, alert a passenger (e.g., the driver) that the occupancy of the vehicle does not meet the requirements of the lane or road. For example, the vehicle 130 may display an alert on the navigation UI of the vehicle.

At block 314, the routine ends.

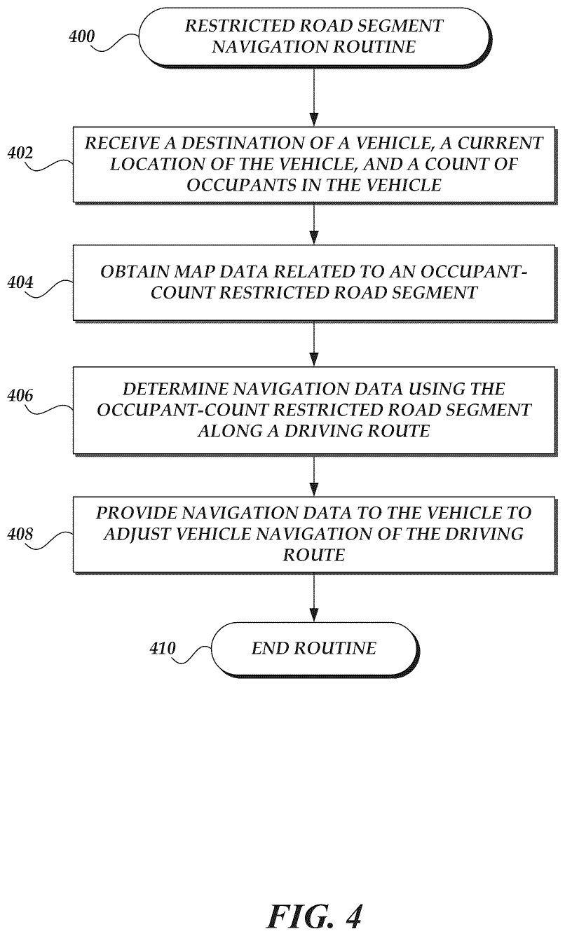

FIG. 4 illustrates an example routine implemented by a server in communication with the vehicle in accordance with some aspects of the disclosure. The routine 400 begins at block 402, where the server 110 may receive a destination of a vehicle, a current location of the vehicle, and metadata indicating a count of occupants in the vehicle. The destination may be input by a user using a navigation (user interface) UI. The destination can indicate a desired destination to navigate the vehicle to. The current location may indicate a current location of the vehicle, for example as identified by GPS sensors in the vehicle. The metadata indicating a count of the occupants in the vehicle may be generated by and received from, for example, the person count estimator 138 as described above.

At block 404, the server 110 may obtain map data related to an occupant-count restricted road segment. The map data may include traffic data, offline maps, online maps, or occupant-restricted road segment entry requirement data. The map data may include, for example, map data source(s) 140 as described above.

At block 406, the server 110 can determine, based on the destination, the current location, the metadata, and the map data, navigation data using the occupant-count restricted road segment along a driving route. The server 110 may determine the navigation data by determining whether the count of occupants is greater than or equal to a minimum number of occupants for entry into the occupant-count restricted road segment. For example, if the count of occupants is 3 and the minimum number of passengers for entry into the occupant-count restricted road segment is 2, then the vehicle may enter the restricted road segment. Then, based on the determination, the server 110 can generate navigation data that indicates to navigate the vehicle into the occupant-count restricted road segment. The navigation data may indicate a route of where to drive the vehicle to get from the current location to the inputted destination and a trajectory using the occupant-count restricted road segment.

At block 408, the server 110 can provide the navigation data to the vehicle to adjust vehicle navigation of the driving route towards the occupant-count restricted road segment. At block 410, the routine ends.

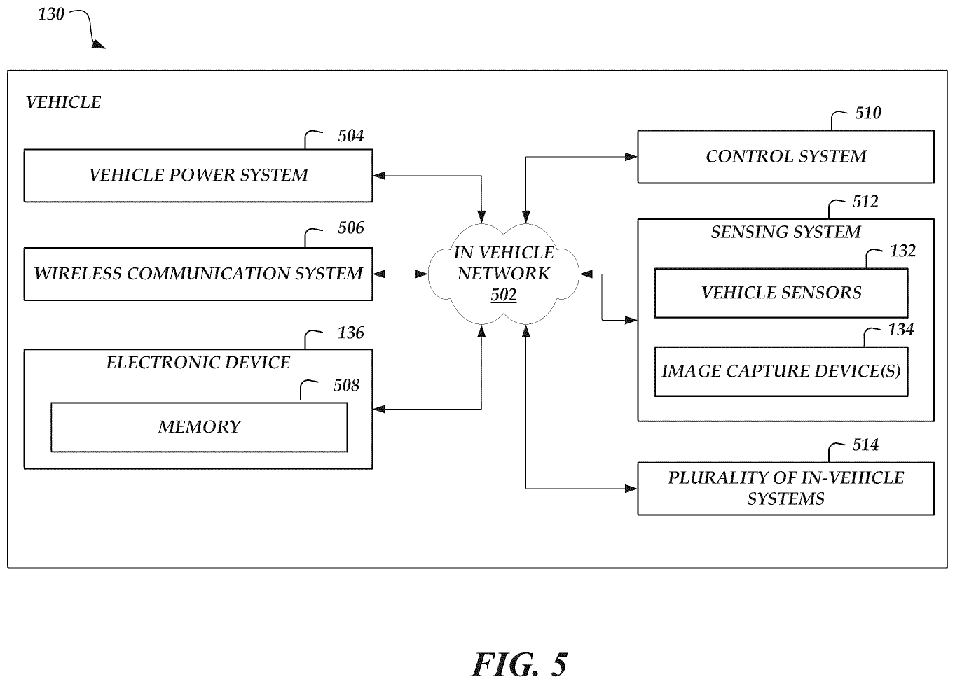

FIG. 5 is a block diagram that illustrates various exemplary components or systems of a vehicle, in accordance with embodiments of the disclosure. FIG. 5 is explained in conjunction with elements from FIG. 1. With reference to FIG. 5, there is shown the vehicle 130. The vehicle 130 may comprise the in-vehicle electronic device 136. The in-vehicle electronic device 136 may be implemented as a part of the IVI system or as an ECU. The in-vehicle electronic device 136 may include a memory 508. The vehicle 130 may comprise a display communicatively coupled to the in-vehicle electronic device 136. In embodiments, the display may be part of the in-vehicle electronic device 136 (e.g., display of an infotainment unit, where the in-vehicle electronic device 136 is implemented as a part of the IVI system). One or more user interfaces (UIs) may be rendered on the display.

The vehicle 130 may further comprise a control system 510, a sensing system 512, and other systems, such as a plurality of in-vehicle systems 514. The control system 510 may include a steering system and a braking system. The sensing system 512 may include a plurality of vehicle sensors 132, a plurality of external cameras and inner cameras, such as the image-capture device(s) 134 of FIG. 1. The plurality of in-vehicle systems 514 may include an HVAC system and a vehicle audio system. The vehicle 130 may further comprise a vehicle power system, a battery, a wireless communication system 506, and an in-vehicle network 502.

The various components or systems may be communicatively coupled via the in-vehicle network 502, such as a vehicle area network (VAN), and/or an in-vehicle data bus. The wireless communication system 506 may be configured to communicate with one or more external devices, and the server 110. A person of ordinary skill in the art will understand that the vehicle 130 may also include other suitable components or systems, in addition to the components or systems which are illustrated herein to describe and explain the function and operation of the present disclosure.

The memory 508 may comprise suitable logic, circuitry, and/or interfaces that may be configured to store a set of instructions executable by circuitry. The memory 508 may store various types of information related to the vehicle 130. Examples of implementation of the memory 508 may include, but are not limited to, Electrically Erasable Programmable Read-Only Memory (EEPROM), Random Access Memory (RAM), Read Only Memory (ROM), Hard Disk Drive (HDD), Flash memory, Solid-State Drive (SSD), and/or CPU cache memory.

The control system 510 may refer to an onboard computer of the vehicle 130 that controls operations of an engine and a transmission system of the vehicle 130. In embodiments, the control system 510 may control ignition, fuel injection (in case of hybrid or non-electric vehicle), emission systems, and/or operations of a transmission system (when provided) and the braking system.

The sensing system 512 may comprise the image-capture device 134 and the plurality of vehicle sensors 132. The plurality of vehicle sensors 132 may include a seat occupancy sensor, a seatbelt buckle latch detector, a radar detector, and the like. The sensing system 512 may be used to sense or detect the sensor data by use of the plurality of vehicle sensors 132 and the interior and exterior cameras, such as the image-capture device(s) 134.

The in-vehicle network 502 may include a medium through which the various control units, components, and/or systems of the vehicle 130 (such as the in-vehicle electronic device 136, display, the control system 510, the sensing system 512, the plurality of in-vehicle systems 514, and the wireless communication system 506) may communicate with each other. In accordance with embodiments, in-vehicle communication of audio/video data for multimedia components may occur by use of Media Oriented Systems Transport (MOST) multimedia network protocol of the in-vehicle network 502 or other suitable networks for audio/video data communication. The MOST-based network may be a separate network from the controller area network (CAN). The MOST-based network may use a plastic optical fiber (POF) medium. In accordance with embodiments, the MOST-based network, the CAN, and other in-vehicle networks may co-exist in a vehicle, such as the vehicle 130. The in-vehicle network 502 may facilitate access control and/or communication between the circuitry 202 and other ECUs, such as ECM or a telematics control unit (TCU) of the vehicle 130. Various devices or components in the vehicle 130 may be configured to connect to the in-vehicle network 502, in accordance with various wired and wireless communication protocols. Examples of the wired and wireless communication protocols for the in-vehicle network 502 may include, but are not limited to, a vehicle area network (VAN), a CAN bus, Domestic Digital Bus (D2B), Time-Triggered Protocol (TTP), FlexRay, IEEE 1394, Carrier Sense Multiple Access With Collision Detection (CSMA/CD) based data communication protocol, Inter-Integrated Circuit (PC), Inter Equipment Bus (IEBus), Society of Automotive Engineers (SAE) J1708, SAE J1939, International Organization for Standardization (ISO) 11992, ISO 11783, Media Oriented Systems Transport (MOST), MOST25, MOST50, MOST150, Plastic optical fiber (POF), Power-line communication (PLC), Serial Peripheral Interface (SPI) bus, and/or Local Interconnect Network (LIN).

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed parallel heatsink. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiments, variation and/or modification relative to, or over, another element, embodiments, variation and/or modification.

It will also be appreciated that one or more of the elements depicted in the drawings/figures can also be implemented in a more separated or integrated manner, or even removed or rendered as inoperable in certain cases, as is useful in accordance with a particular application.

What is claimed is:

1. A method performed by a processor in a vehicle, comprising:
receiving passenger sensor data from the vehicle;
determining, based on the passenger sensor data from inside the vehicle, a count of number of passengers in the vehicle;
determining an occupant-count restricted road segment in an environment of the vehicle; and
adjusting vehicle navigation of a driving route to enter the occupant-count restricted road segment based on the count.

2. The method of claim 1, further comprising:
transmitting the count, a current location, and a destination to an outside server, wherein the outside server determines navigation data for routing the vehicle; and
receiving the navigation data from the outside server based on the count, the current location, and the destination.

3. The method of claim 1, wherein the passenger sensor data is received from inside the vehicle from at least one of: one or more seat occupancy sensors, one or more seatbelt latch detectors, one or more radar sensors, or one or more interior cameras.

4. The method of claim 1, further comprising:
determining, based on at least one of: sensor data from outside the vehicle or map data, existence of the occupant-count restricted road segment.

5. The method of claim 4, wherein the map data comprises at least one of: traffic data, offline maps, online maps, or occupant-restricted road segment entry requirement data.

6. The method of claim 1, wherein adjusting the vehicle navigation comprises self driving the vehicle to the occupant-count restricted road segment.

7. The method of claim 1, wherein adjusting the vehicle navigation comprises displaying an indication to a driver of the vehicle to drive to the occupant-count restricted road segment.

8. The method of claim 1, further comprising:
inputting the count into an occupant-count restricted road segment transponder.

9. The method of claim 1, wherein determining, based on the passenger sensor data from the vehicle, the count of number of passengers in the vehicle comprises:
identifying one or more passengers in the vehicle based on the passenger sensor data wherein the passenger sensor data indicates a presence of the one or more passengers; and
summing the identified passengers in the vehicle to determine the count.

10. The method of claim 1, wherein determining the count of number of passengers in the vehicle comprises:
applying a first weight a first set of passenger sensor data and a second weight to a second set of passenger sensor data; and
based on the first weight, the first set of passenger sensor data, the second weight, and the second set of passenger sensor data, determining whether individual seats of the vehicle are occupied with a passenger.

11. A system, comprising:
one or more processors and computer storage media storing instructions that when executed by the processors, cause the processors to:
receive passenger sensor data from a vehicle;
determine, based on the passenger sensor data from inside the vehicle, a count of number of passengers in the vehicle;
determine an occupant-count restricted road segment in an environment of the vehicle; and
adjust vehicle navigation of a driving route to enter the occupant-count restricted road segment based on the count.

12. The system of claim 11, wherein to determine, based on the passenger sensor data from the vehicle, the count of number of passengers in the vehicle further causes the processors to:
identify one or more passengers in the vehicle based on the passenger sensor data from the vehicle, wherein the passenger sensor data from the vehicle indicate a presence of the one or more passengers; and
sum the identified passengers in the vehicle to determine the count.

13. The system of claim 11, wherein the instructions further cause the processors to:
determine, based on at least one of: sensor data from outside the vehicle or map data, existence of the occupant-count restricted road segment.

14. The system of claim 13, wherein the map data comprises at least one of: traffic data, offline maps, online maps, or occupant-count restricted road segment entry requirement data.

15. The system of claim 11, wherein the passenger sensor data is received from inside the vehicle from at least one of: one or more seat occupancy sensors, one or more seatbelt latch detectors, one or more radar sensors, or one or more interior cameras.

16. A computer program product, the computer program product being embodied in a non-transitory computer readable storage medium and comprising computer instructions for:
receiving passenger sensor data from a vehicle;
determining, based on the passenger sensor data from inside the vehicle, a count of number of passengers in the vehicle;
determining an occupant-count restricted road segment in an environment of the vehicle; and
adjusting vehicle navigation of a driving route to enter the occupant-count restricted road segment based on the count.

17. The computer program product of claim 16, wherein the passenger sensor data is received from inside the vehicle from at least one of: one or more seat occupancy sensors, one or more seatbelt latch detectors, one or more radar sensors, or one or more interior cameras.

18. The computer program product of claim 16, further comprising computer instructions for:
determining, based on image data from outside the vehicle and map data, an existence of the occupant-count restricted road segment.

19. The computer program product of claim 18, wherein the map data comprises at least one of: traffic data, offline maps, online maps, or occupant-restricted road segment entry requirement data.

20. The computer program product of claim 16, further comprising:
transmitting the count, a current location, and a destination to an outside server, wherein the outside server determines navigation data for routing the vehicle; and
receiving the navigation data from the outside server based on the count, the current location, and the destination.
